(19) United States
(12) Patent Application Publication
(10) Pub. No.: US 2002/0166705 A1
(43) Pub. Date: Nov. 14, 2002

(54) Fish weigh-in basket

(76) Inventor: Max L. Swayze, Monroe, LA (US)

Correspondence Address: Richard C. Litman, LITMAN LAW OFFICES, LTD., P.O. Box 15035, Arlington, VA, 22215, US

(21) Appl. No.: 09/849,995

(22) Filed: May 8, 2001

(51) Int. Cl. G01G 19/56

(52) U.S. Cl. 177/253

(57) ABSTRACT

A fish catch weigh-in basket system comprising an accordion-like pleated fish holding rack with five parallel troughs formed on an upper surface. The rack has a flat bottom surface made from a closed cell plastic foam, and is dimensioned to fit snugly in the bottom of a rectangular-shaped plastic basket for weighing at least five live fish laid upside down at a time in a fishing tournament to weigh the catch of a contestant and to minimize the weigh-in time for all contestants.

### BACKGROUND OF THE INVENTION

1. Field of the Invention

The present invention relates generally to sport fishing accessories. More specifically, the invention is an accordion-pleated fish holder in a basket for substantially immobilizing the catch during the weighing of the fish in a basket to weigh the catch of a contestant in a fishing tournament.

2. Description of the Related Art

The related art of interest describes various fish weighing paraphernalia, but none discloses the present invention. There is a need for a fish immobilizing basket for weighing the catch in a fishing tournament in order to decrease the waiting time in line, losing valuable total weight and enabling a faster return of the live fish catch back to the water. The related art will be discussed in the order of perceived relevance to the present invention.

U.S. Pat. No. 4,696,360 issued on Sep. 29, 1987, to Manny Homen describes a live fish weighing apparatus for sports fishermen and the like comprising a rectangular box with a hinged cover and a guide member on its bottom for slidably mounting on a weighing scale having a “hold” readout button. The apparatus is distinguishable for failing to suggest any need for another fish immobilizing member inside the box, because the live fish will still flop around making it difficult to get a stable weight reading except for the “hold” readout.

U.S. Pat. No. 5,098,338 issued on Mar. 24, 1992, to John A. Jensen describes a portable fish cleaner device for removably attaching to the outside surface of a boat gunwale comprising a pair of fixed brackets on the boat which holds a flat cutting board and a V-shaped trough supported by a pair of angular supports. The ends of the trough have cords to prevent a fish from escaping. The device is distinguishable for its unique cutting board structure.

U.S. Pat. No. 5,637,838 issued on Jun. 10, 1997, to Clyde D. Arey et al. describes an apparatus for measuring, weighing and counting fish comprising a rectangular board having a slidable extension at one end with a length scale and a V-shaped recess proximate the opposite end for holding the head of the fish. A manual counter and a weight scale are also provided at the opposite end. The apparatus is distinguishable for its required measuring, weighing and counting elements.

U.S. Design Pat. No. 420,704 issued on Feb. 15, 2000, to Matthew Coe describes a corrugated display device with a clock on one end. U.S. Pat. No. 3,967,023 issued on Jun. 29, 1976, to Franz Lysek describes an accordion-pleated channel-shaped cover for guide tracks of machines having an open side and kink-resistant sheet-material sewn into the interior of its pleats along the outer edge regions. U.S. Design Pat No. 334,867 issued on Apr. 20, 1993, to Ronald W. May describes an ornamental taco preparation stand having four peaks and three grooves formed from a thin material. U.S. Design Pat. No. 335,425 issued on May 11, 1993, to Jackie N. Shular describes an ornamental taco holder having three peaks and two grooves. U.S. Pat. No. 5,628,245 issued on May 13, 1997, to Mark E. Baze describes a utensil for forming tortillas into baked taco shells having a series of linear, parallel spaced crests in the shape of inverted, round bottomed “V”s and having perforated crests. These corrugated devices are distinguishable for their thin structures.

None of the above inventions and patents, taken either singularly or in combination, is seen to describe the instant invention as claimed. Thus, a multiple fish weigh-in basket solving the aforementioned problems is desired.

### SUMMARY OF THE INVENTION

The present invention is a multiple live fish holder and weigh-in basket for fishing tournaments which would minimize the waiting time for all contestants with their catches and the possible loss of total fish weight. The live fish holder comprises a solid accordion-pleated rack providing at least five troughs for holding live fish upside down in a rectangular basket. This technique results in less flopping around of the catch during the weigh-in and less waiting until the officials can weigh the catch. The live catch can be released earlier due to this invention.

Accordingly, it is a principal object of the invention to provide a weigh-in basket with a fish-holding rack.

It is another object of the invention to provide a weigh-in basket with a rack having at least three longitudinal troughs for holding and immobilizing the fish.

It is a further object of the invention to provide a rack having at least four longitudinal ridges.

Still another object of the invention is to provide a method of confining a fish catch in a weigh-in basket by placing the fish upside down in the troughs of the rack.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a fish upside down in a trough of a rack inside a rectangular weigh-in basket according to the present invention.

FIG. 2 is a perspective view of the rectangular fish holding rack showing parallel ridges and troughs.

Similar reference characters denote corresponding features consistently throughout the attached drawings.

### DETAILED DESCRIPTION OF THE PREFERRED EMBODIMENT

When fishing tournaments are held, the contestants must line up with their catches while each catch is weighed. However, the weighing-in takes undue time because the officials will not weigh flopping fish, since the weight measurements would be erratic. The officials and the waiting fishermen must wait until the fish stop flopping to take an official weight. This results in a longer wait for all and loss of important weight of the fish catch. Normally, five fish are weighed at a time. A loss of an ounce of weight due to waiting can result in loss of prize money. This device eliminates undue waiting for the flopping fish to settle down and the possible loss of a monetary prize by capturing the fish in troughs or grooves when laid upside down.

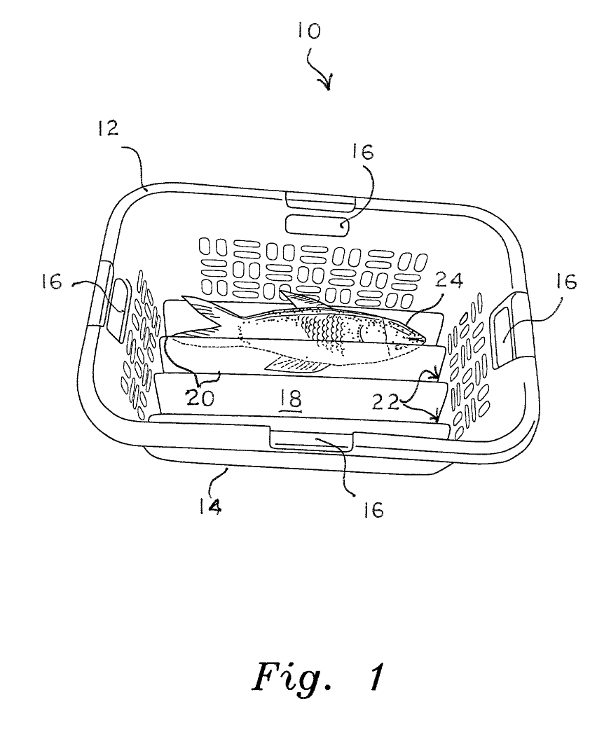

The present invention is illustrated in FIG. 1 as a fish weigh-in basket 10 for use in bass fishing tournaments to minimize the problem of a flopping fish catch during weigh-in at a fishing tournament for smallmouth or largemouth bass, a problem which causes an aggravating waiting in line for the other contestants and valuable loss in total weight of each catch. A maximum of five fish are weighed at a time in a bass tournament.

A conventional rectangular plastic basket 12 having a flat bottom 14 and apertured handles 16 is utilized. A rectangular multiple fish positioning rack 18 comprises a plurality of parallel alternating ridges 20, i.e., 4, and troughs 22 having a sharp V-shaped bottom, i.e., 3, is placed at the bottom 14 of the basket 12. Thus, the rack 18 provides effectively 5 troughs 22 (with the aid of the sides of the basket 12) for placement of caught live bass 24 upside down, i.e., with the dorsal fins caught in each trough 22. This inverted placement of the live bass 24 surprisingly prevents the bass from flopping all over the bottom of the basket 12, and thus enabling the weighing of the live catch without waiting for the bass to settle down and delaying the waiting process for the other fishermen with their catches. The net weight of the fish catch would be obtained by weighing the basket 12 and the rack 18 after the fish catch has been removed.

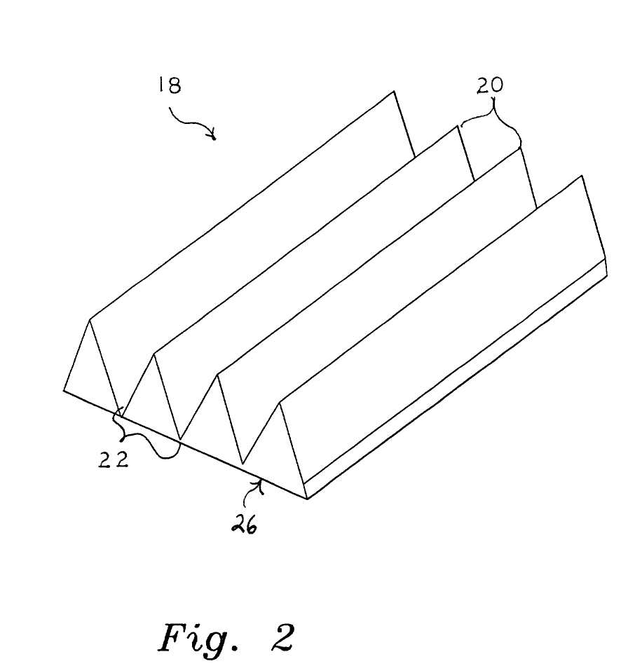

The rack 18 illustrated in FIG. 2 is made of a molded dense, closed cell foam plastic and has a solid flat bottom 26.

It has been found that wood would not do as a rack material because it would crack and absorb liquid. A styrofoam rack would not do also because of its flexibility and excessive absorption of liquid.

Other advantages of using this invention in fishing tournaments would result in more accurate readings by the officials, and increase the weighed amount in ounces of the catch which can result in gaining a prize worth much. Also, the fish can be released quicker to survive.

It is to be understood that the present invention is not limited to the embodiment described above, but encompasses any and all embodiments within the scope of the following claims.

I claim:

1. A fish weigh-in basket system for fishing tournaments comprising:
a plastic basket having a flat bottom; and
a multiple fish positioning rack having a plurality of parallel alternating ridges and troughs disposed in the bottom of said basket;
wherein live fish can be placed upside down in the troughs to minimize any flopping around for a faster weighing in time.

2. The fish weigh-in basket system according to claim 1, wherein the plurality of ridges and troughs consists of four ridges and three troughs.

3. The fish weigh-in basket system according to claim 1, wherein each trough has a sharp V-shaped bottom for trapping the dorsal fin of the live fish.

4. The fish weigh-in basket system according to claim 1, wherein the rack is made of a dense closed cell foam plastic.

5. The fish weigh-in basket system according to claim 1, wherein the rack has a solid flat bottom.

6. A method of weighing in fish for a fish tournament comprising:
providing a plastic basket having a flat bottom; and
providing a multiple fish positioning rack comprising a plurality of parallel alternating ridges and troughs disposed in the bottom of the basket;
placing each live fish upside down in a trough; and
weighing the live fish in the troughs to minimize any flopping around for a faster weighing in time.

7. The method according to claim 6, wherein the plurality of ridges and troughs consists of four ridges and three troughs.

8. The method according to claim 6, wherein each trough has a sharp V-shaped bottom for trapping the dorsal fin of the live fish.

9. The method according to claim 6, wherein the rack is made of a dense closed cell foam plastic.

10. The method according to claim 6, wherein the rack has a solid flat bottom.

11. The method according to claim 6, further comprising the steps of:
removing the live fish from the basket; and
weighing the basket and rack with the live fish removed from the basket. I1
